(19) United States
(12) Patent Application Publication
(10) Pub. No.: US 2004/0073462 A1
(43) Pub. Date: Apr. 15, 2004

(54) System and method for pharmacy restocking applications

(76) Inventors: Morris G. Cazzell, Weston, FL (US); Nicholas J. Marchalleck, Weston, FL (US)

Correspondence Address: RUDEN, MCCLOSKY, SMITH, SCHUSTER & RUSSELL, P.A., P.O. BOX 1900, FORT LAUDERDALE, FL, 33301, US

(21) Appl. No.: 10/637,816

(22) Filed: Aug. 8, 2003

Related U.S. Application Data
(60) Provisional application No. 60/402,069, filed on Aug. 9, 2002.
(60) Provisional application No. 60/457,475, filed on Mar. 25, 2003.

(51) Int. Cl. G06F 17/60

(52) U.S. Cl. 705/3

(57) ABSTRACT

A computer-implemented system for the transmission, reception, and storage of restocking information for pharmacy applications between a user and a provider is disclosed, the system including a provider database having memory and a plurality of provider function databases, wherein at least one first provider function database of the plurality of provider function databases is in communication with at least one second provider function database of the plurality of provider function databases, at least one remote user database having memory and capable of accessing said plurality of provider function databases, and wherein the plurality of provider function databases is searchable by the at least one remote user database for item data and order data.

### CROSS-REFERENCES TO RELATED APPLICATIONS

This application claims the benefit of U.S. Provisional Application Serial No. 60/402,069, filed on Aug. 9, 2002, entitled APPARATUS AND TECHNIQUES FOR PHARMACY RESTOCKING APPLICATIONS and U.S. Provisional Application Ser. No. 60/457,475, filed on Mar. 25, 2003, entitled APPARATUS AND TECHNIQUES FOR PHARMACY RESTOCKING APPLICATIONS.

### TECHNICAL FIELD

The present invention relates generally to electronic transactions for restocking applications. Specifically, the present invention relates to an electronic restocking system and method that permits the transmission, reception, and storage of restocking information for pharmacy applications between a user and a provider.

### BACKGROUND OF THE INVENTION

Automated pharmaceutical restocking systems have been utilized for several decades. The initial purposes of such systems were to reduce the excessive rates of errors associated with the manual distribution of medications. Recently, automated systems have presented significant advantages for pharmacy applications. Such advantages include the further reduction of errors, lower costs associated with pharmaceutical distribution, reduction of personnel, inventory control, substance control, automated documentation, and relieving professional pharmacists of numerous tasks associated with the foregoing.

Currently most systems for tracking inventory and use of medicinal-related items in a hospital, pharmacy, or other environment are largely manual systems. The persons responsible for maintaining an inventory of particular items must monitor the use of the items in each storage location within the hospital or pharmacy and order additional supplies when it is noted that the available stocks are running low. Often personnel are only familiar with particular, specific items available from a supplier and as a result, additional or substitute items are not ordered even though ample supplies are available from the same supplier or such items are more cost effective to the patient.

Thus there exists a need for a system that permits the transmission, reception, and storage of restocking information for pharmacy applications between a user and a provider and that can more accurately monitor and order from supplier inventories. There further exists a need for a method for the restocking of pharmacy inventories in such a system that provides more accurate, convenient and secure movement of inventory items from a supplier to a pharmacy or other location where medicinal items are dispensed.

### SUMMARY OF THE INVENTION

The present invention addresses the above-mentioned needs by providing a system that permits the transmission, reception, and storage of restocking information for pharmacy applications between a user and a provider and that can more accurately monitor and order from supplier inventories, as well as a method and system for the restocking of pharmacy inventories in such a system that provides more accurate, convenient and secure movement of inventory items from a supplier to a pharmacy or other location where medicinal items are dispensed.

In accordance with the present invention, there is provided a computer-implemented system for the transmission, reception, and storage of restocking information for pharmacy applications between a user and a provider, the system including a provider database having memory and a plurality of provider function databases, wherein at least one first provider function database of the plurality of provider function databases is in communication with at least one second provider function database of the plurality of provider function databases, at least one remote user database having memory and capable of accessing the plurality of provider function databases, and wherein the plurality of provider function databases is searchable by the at least one remote user database for item data and order data.

The present invention is further directed to a method of transmitting, receiving, and storing restocking information for pharmacy applications between a user and a provider, the method including the steps of providing a provider database having memory and a plurality of provider function databases, wherein at least one first provider function database of the plurality of provider function databases is in communication with at least one second provider function database of the plurality of provider function databases; accessing the plurality of provider function databases with at least one remote user database having memory; and searching the plurality of provider function databases for item data and order data.

### BRIEF DESCRIPTION OF THE FIGURES

FIG. 1 is a flow chart diagram of the preferred embodiment of the present invention.

FIG. 2 is a flow chart diagram of the Search selection of FIG. 1.

FIG. 3 is a flow chart diagram of the Order List selection of FIG. 1.

FIG. 4 is a flow chart diagram of the Wantbook selection of FIG. 1.

FIG. 5 is a flow chart diagram of the Last Order selection of FIG. 1.

FIG. 6 is a flow chart diagram of the Hot List selection of FIG. 1.

FIG. 7 is a flow chart diagram of the Messages selection of FIG. 1.

FIG. 8 is a flow chart diagram of the Item Detail option of FIG. 1.

FIG. 9 is a flow chart diagram of the Quantity Form.

FIG. 10 is a representative screen shot of the application of the preferred embodiment.

FIG. 11 is a representative screen shot of the initialize program step of FIG. 1.

FIG. 12 is a representative screen shot of the Main Menu of FIG. 1.

FIG. 13 is a representative screen shot of the Search and Search Form of FIG. 2.

FIG. 14 is a representative screen shot of the Search Results of FIG. 2.

FIG. 15 is a representative screen shot of the Search Results, including Manufacturers, sorted by price of FIG. 2.

FIG. 16 is a representative screen shot of the Quantity Form of FIG. 2.

FIG. 17 is a representative screen shot of the Order List of FIG. 3.

FIG. 18 is a representative screen shot of the Wantbook of FIG. 4.

FIG. 19 is a representative screen shot of the Last Order of FIG. 5.

FIG. 20 is a representative screen shot of the Hot List of FIG. 6.

FIG. 21 is a representative screen shot of the Item Detail of FIG. 8.

FIG. 22 is a representative screen shot of the Messages Display of FIG. 7.

### DETAILED DESCRIPTION OF THE INVENTION

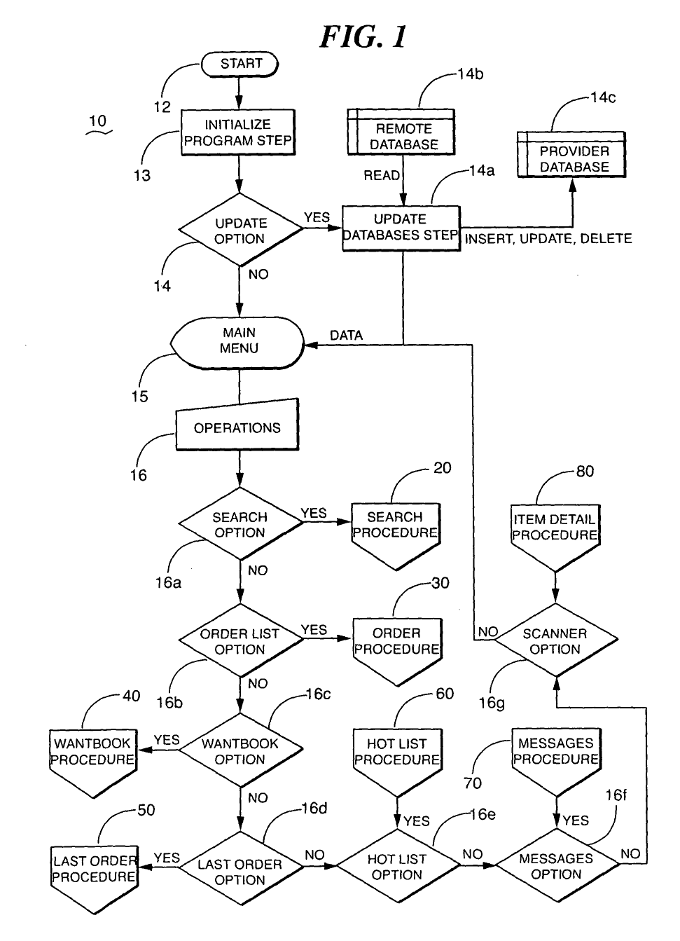

The system and method for pharmacy restocking methods illustrated in FIGS. 1-22 can be provided in software for single-user or multi-user operation on a computer network, such as a local area network or the Internet, for use, for example, by pharmacists and other prescribers within a single facility, pharmacy, hospital, group practice, or like prescribing organization, and the invention can bring substantial benefits to such users and their suppliers. Additionally, the ability of the system to communicate data transactions related to inventory, pricing, orders, and order verification-via the Internet from any location in the world with local telephone access results in an extremely low cost of data communications from remote sites with no long distance communications charges.

Further significant benefits can accrue to pharmacists, patients, physicians, drug suppliers and the public at large by implementation of the described restocking system on a regional, nation-wide, or worldwide basis. To this end, a preferred embodiment of prescription management system comprises a provider facility supporting wired or wireless network delivery of Provider Database information of said restocking system to multiple remote user interface devices, such as handheld devices or personal digital assistants (“PDA's”) containing Remote Databases.

The provider facility provides data, or access to databases of data, data processing and communications resources for users to draw upon via the user interface devices. The provider facility can be a server or cluster of servers with associated data storage volumes, and at least one intelligent client providing access to the server or servers. As will be explained in more detail hereinafter, the provider facility can call upon a variety of resources and functions as a marshalling and processing center for organizing resources into useful and manageable pieces for utilization by limited capacity user-interface devices. In a preferred embodiment it is a coordination point on a network for a number of user-device clients. Preferably the network accesses or includes a remote database to provide useful information to the system.

The restocking system shown in this embodiment of the invention has been designed for implementation on physically compact, portable, user-interface devices such as small portable personal computers, particularly PDA's. Those skilled in the art will understand that the system can readily be used on or adapted to other hardware platforms, for example, a desktop computer and can be expressed in different software interfaces from that shown, especially ones that use different input devices such as keyboards, touch pads or touch screens and the like.

Ease of use and suitability of the system to keyless or minimally keyed platforms, especially PDA's, is promoted by minimizing the need for actual text or data entry by the user and by emphasizing instead data selection from extensive, preferably comprehensive, databases. Preferred embodiments of the invention allow quick stylus selection of data items through database listings.

The databases, listings, or routes, can be organized in multiple hierarchies for rapid and flexible access to multiple large, remote databases, via multiple access routes to retrieve multiple related data elements.

A desirable goal is to provide the pharmacist-user with intelligent databases that are, where possible, exhaustive and list, for example, all prescribable drugs, all prices, all stock numbers, all product codes and present the pharmacist with helpful selections or defaults selected intelligently on the basis of historical data known to the system. Preferably, the selections are fully system embodied, or automatic, operating transparently to the user and requiring a minimum of configurational or setup operations by the user.

As detailed below, the components of the system are interchangeably used as both nouns and descriptive words or phrases. Such use is not intended to limit the following description.

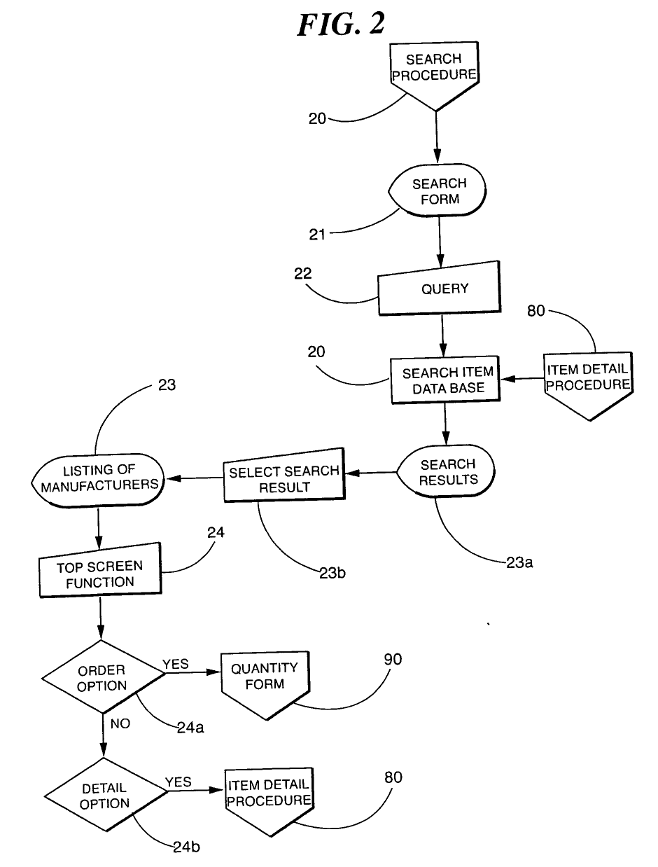

Referring now to FIG. 1, a preferred embodiment of the present invention is illustrated as restocking system 10. Restocking system 10 includes a Provider Database 14c containing a plurality of provider function databases, the plurality provider function databases including at least one first provider function database in communication with at least one second provider function database and at least one Remote Database 14b. The first and second provider function databases are preferably selected from the group consisting of an Item Database 23, Order Database 31b, Wantbook Database 42, Last Order Database 52, Hot List Database 62, and Messages Database 72, as shown in FIGS. 2-7, discussed below. Both Provider Database 14c and Remote Database 14b of restocking system 10 contain selections for Start 12 and Operations 16, including Search Option 16a, Order List Option 16b, Wantbook Option 16c, Last Order Option 16d, Hot List Option 16e, Messages Option 16f, and Scanner Option 16g. Preferably, the user will engage Remote Database 14b via a handheld device at a user location, such as a pharmacy, while Provider Database 14c is situated at a provider location, such as a storage or manufacturing facility.

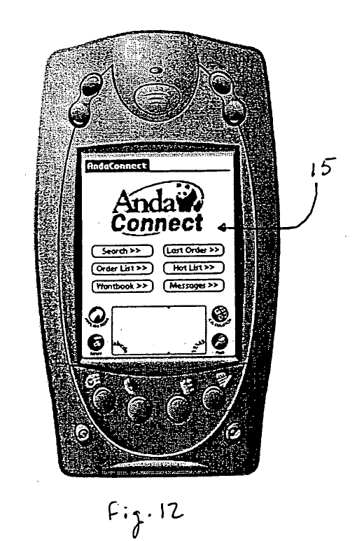

Start 12, as illustrated in FIGS. 1 and 10, when selected, provides for Initialize Program Step 13. Initialize Program Step 13, as further illustrated in FIG. 11, boots the program that runs the software of restocking system 10. As Initialize Program Step 13 is run, restocking system 10 checks for Updates 14 originating from Provider Database 14c. If restocking system 10 identifies Updates 14, then restocking system conducts Update Databases Step 14a. Update Databases Step 14a updates information contained in memory of Remote Database 14b. Additionally memory of Provider Database 14c can be updated, as required, with information provided by Remote Database 14b. Preferably, Provider Database 14c is updated upon transmission of an order from Remote Database 14b via a communication over a communications network, such as a computer network, as is known in the art and further discussed below.

Remote Database 14b contains information or data including, but not limited to, item data, order data, price data, stock data, and the like. Provider database 14c similarly contains information including, but not limited to, item data, price data, stock data, product scan codes, and the like. Preferably, Update Databases Step 14a updates information contained in memories of Remote Database 14b and Provider Database 14c by inserting, updating, and/or deleting information.

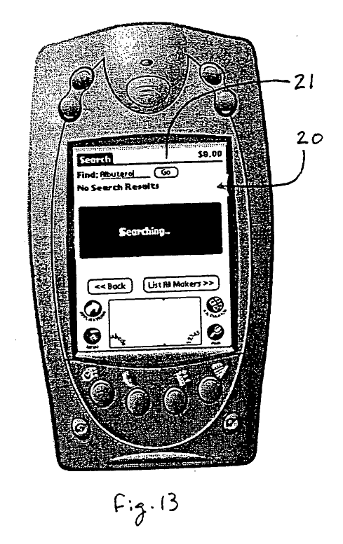

Additionally, restocking system 10 includes a Main Menu 15, illustrated in FIGS. 1 and 12. As shown in remote database 14b of FIG. 12 and illustrated by the flow chart of FIG. 1, Main Menu 15 contains Operations 16, including Search Option 16a, Order List Option 16b, Wantbook Option 16c, Last Order Option 16d, Hot List Option 16e, and Messages Option 16f. As an example, a user can engage Main Menu 15 on handheld device 100 containing Remote Database 14b to perform Search Option 16a, Order List Option 16b, Wantbook Option 16c, Last Order Option 16d, Hot List Option 16e, and/or Messages Option 16f.

### Search Option

As illustrated in FIGS. 1 and 2, once the user chooses Search Option 16a, the software contained in Remote Database 14b begins Search Procedure 20. Search Procedure 20 presents the user with a Search Form 21, as is further shown in FIG. 13. Search Form 21 is filled out by the user, for example, by entering a criterion such as an item name, such as “Albuterol.” Other criteria that may be entered include, but are not limited to, product codes, stock numbers, prices, and the like. Once Search Form 21 is completed and the user selects Query 22, Remote Database 14b searches the contents of Item Database 23 using data entered in Item Detail Procedure 80.

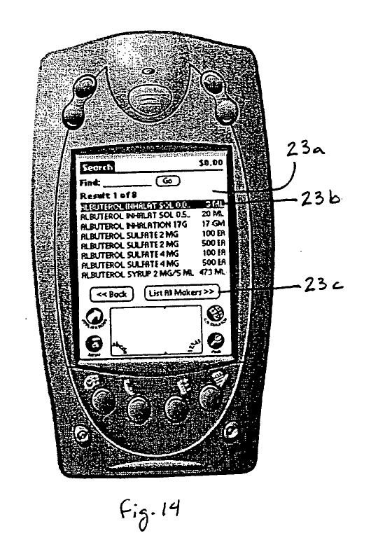

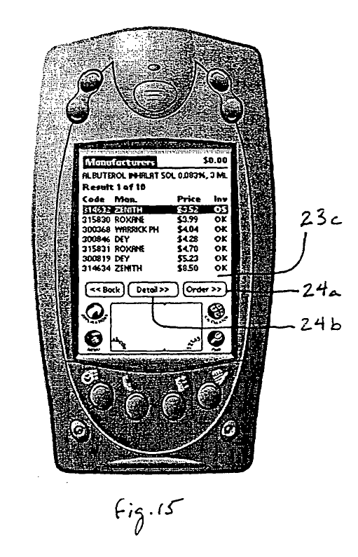

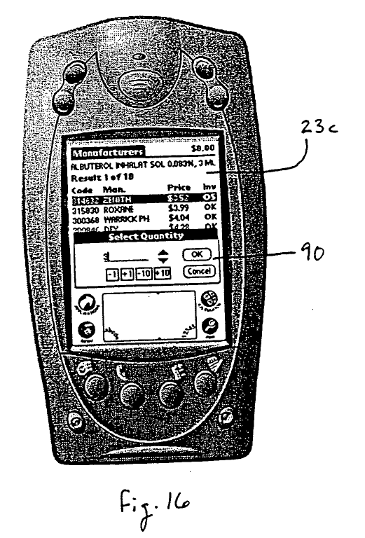

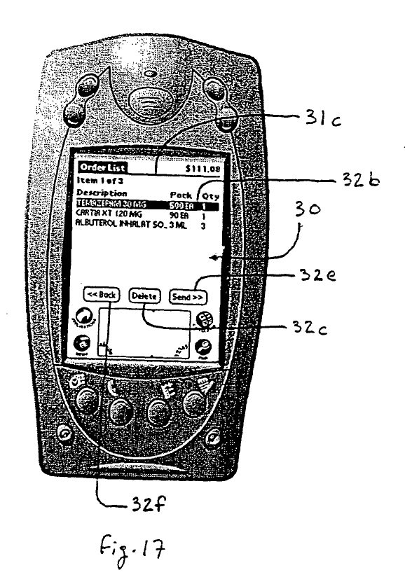

Searching the contents of Item Database 23 generates Search Results 23a, which contain data, such as item data, as illustrated in FIGS. 2 and 14. Item data includes an item identifier, item name, description, manufacturer, price, status, available sizes, similar items, and best prices. The user can then Select Search Result 23b, as shown by the example highlighted as “ALBUTEROL INHALAT SOL 0.0 . . . 3 ML,” and subsequently select a Listing Of Manufacturers 23c, sorted by price, as illustrated in FIG. 15. In the above example, “ALBUTEROL” is the item name, “INHALAT SOL O.O” is the description, and “3 ML” is the available size. Upon presentation of Listing Of Manufacturers 23c, the user can perform a Tap Screen Function 24 to select a particular item, such as “314632 ZENITH $3.62 OS” shown in the example in FIG. 15. In this example, “314632” is the item identifier, “ZENITH” is the manufacturer, “$3.62” is the price, and “OS” is the status (out of stock). By selecting a particular item, the user can then select Order Option 24a to order the selected item and/or Detail Option 24b to obtain information regarding the selected item. Selecting Order Option 24a generates a Quantity Form 90, shown in FIG. 16, which the user completes so as to place the item and its desired quantity into Order Database 31b.

### Quantity Form

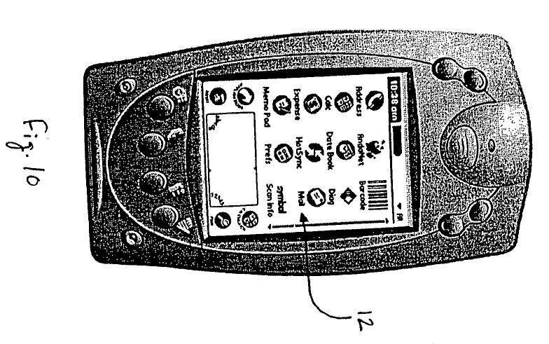

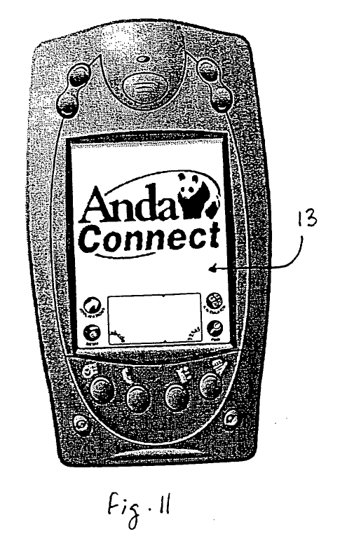

As illustrated in FIG. 9, Quantity Form 90 permits the user to enter a desired quantity of an item, cancel/delete quantities of an item, and/or add quantities of an item through Quantity Function 91. Upon entry of the desired quantity of an item the user may opt for Cancel Function 91a to cancel Quantity Function 91 and close Quantity Form 90, or Add Function 91b to update Order Database 31b (discussed below) and Back To Previous Screen 92.

### Order List Option

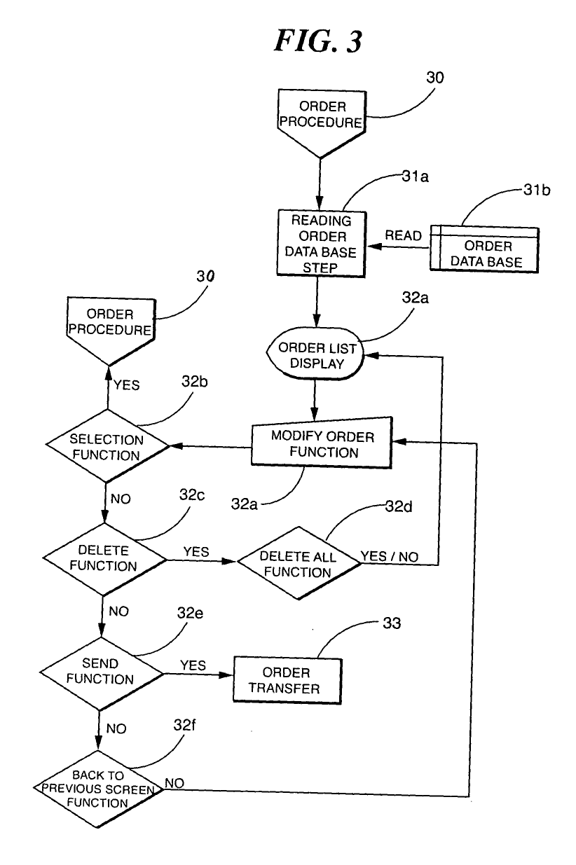

If the user does not opt to perform a search from Main Menu 15, the user may select Order List Option 16b, as shown in FIG. 1. Selecting Order List Option 16b causes the software contained in Remote Database 14b to begin Order Procedure 30. As illustrated in FIG. 3, Order Procedure 30 includes Reading Order Database Step 31a that scans Order Database 31b. Upon completion of Reading Order Database Step 31a, an Order List Display 31c is generated presenting order data to the user. Order data can include an item identifier, description and quantity.

Order List Display 31c, as illustrated in FIG. 3 and further shown in FIG. 17, permits the user to select and delete an item presented in the order data, send the order list, and/or return to a previous screen through Modify Order Function 32a. Items are selected by the user through Selection Function 32b, for example, “TEMAZEPAM 30 MG 500EA 1” is illustrated as selected in FIG. 17. In this example, “TEMAZEPAM 30 MG” is the description and “1” is the quantity. Once an item is selected, the user can remove the item from Order List Database 31b by choosing Delete Function 32c. An additional Delete All Function 32d can be provided to delete all items from Order List Database 31b. If removal of the item from Order Database 31b is not desired, the user can transfer the item or the entire order list to Order Transfer 33 by selecting Send Function 32e. Order List Transfer 33 updates Provider Database 14c, including the plurality of provider function databases contained therein, of restocking system 10, as well as Remote Database 14b. A previous screen can be viewed by selecting Back Function 32f.

In the preferred embodiment of the present invention, Remote Database 14b transmits an order by way of Send Function 32e transmitted by a communication device, such as by a modem, through a computer network, such as an intranet or the Internet. The communication device can be wireless, as is well known in the art.

### Wantbook Option

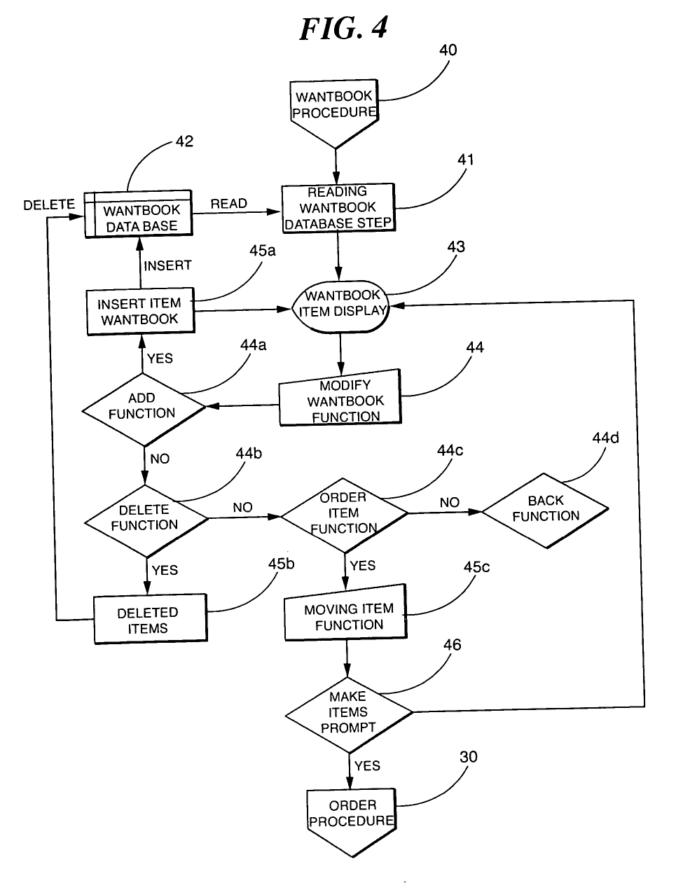

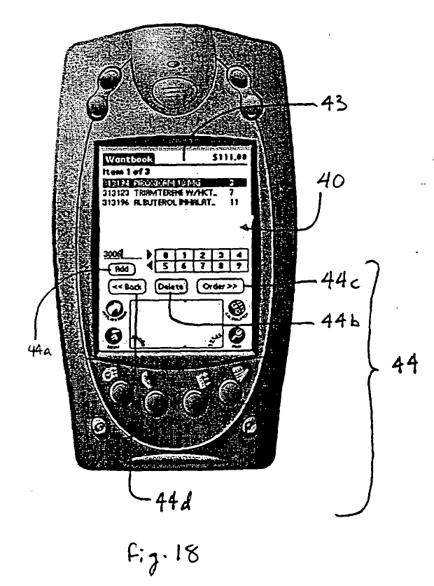

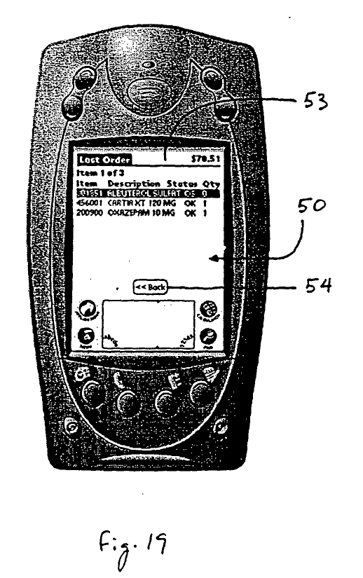

Referring again to FIG. 1, the user can select Wantbook Option 16c. Selecting Wantbook Option 16b causes the software contained in Remote Database 14b to begin Wantbook Procedure 40. As illustrated in FIG. 4, Wantbook Procedure 40 includes Reading Wantbook Database Step 41 that scans Wantbook Database 42. Upon completion of Reading Wantbook Database Step 41, a Wantbook Item Display 43 is generated, as illustrated in FIG. 18.

Wantbook Item Display 43, as shown in FIGS. 4 and 18, permits the user to enter an item number or code, such as the “3006” illustrated as an example in FIG. 18, and delete an item corresponding to the code or a portion thereof, add an item corresponding to the code or a portion thereof, order an item corresponding to the code or a portion thereof, and/or return to a previous screen through Modify Wantbook Function 44.

If the user elects to add an item to Wantbook Database 42, Add Function 44a is selected to insert items via Insert Item Wantbook 45a. Should the user desire to delete an item from Wantbook Database 42, Delete Function 44b is selected to facilitate the removal of Deleted Items 45b. Additionally, if the user desires to order items, Order Item Function 44c is selected. Selecting Order Item Function 44c causes Moving Item Function 45c to provide the user with a Move Items Prompt 46. The user can then decide to move items to Order Procedure 30 for placement in Order Database 31b, or to not move items to Order Procedure 30 and return to Wantbook Item Display 43 via Back Function 44d.

### Last Order Option

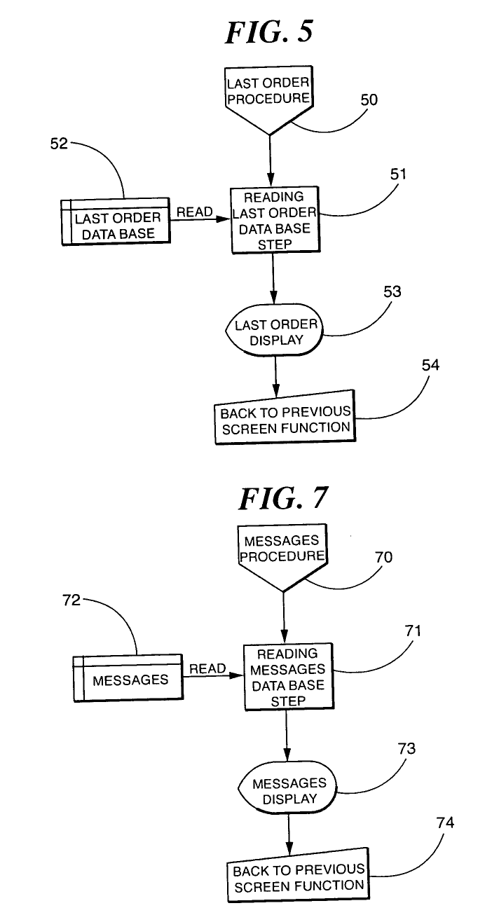

Again referring to FIG. 1, the user can select Last Order Option 16d. Selecting Last Order Option 16d causes the software contained in Remote Database 14b to begin Last Order Procedure 50. As illustrated in FIG. 5, Last Order Procedure 50 includes Reading Last Order Database Step 51 that scans Last Order Database 52. Upon completion of Reading Last Order Database Step 51, a Last Order Display 53 is generated, as illustrated in FIG. 19. A Back To Previous Screen Function 54 is provided in Last Order Display 53. Last Order Display 53 presents prior order data and permits the user to identify orders previously made, so as to reduce or eliminate over-ordering of items and to confirm the status of an order. As illustrated in FIG. 19, Status Column 53a indicates and displays the results of the last order placed with the shipping status of the items ordered. The status of each item on the order can be indicated in Status Column 53a through the use and display of predefined status codes. By way of example, “OK” can be used to indicate that the item is in stock and the quantity desired is available; “CG” can be used to indicate that an item quantity has changed; and “OS” can be used to indicate that an item is out of stock. As illustrated in FIG. 19, “301851 ALBUTEROL SULFAT OS 0” shows that the item “ALBUTEROL SULFAT” is out of stock.

### Hot List Option

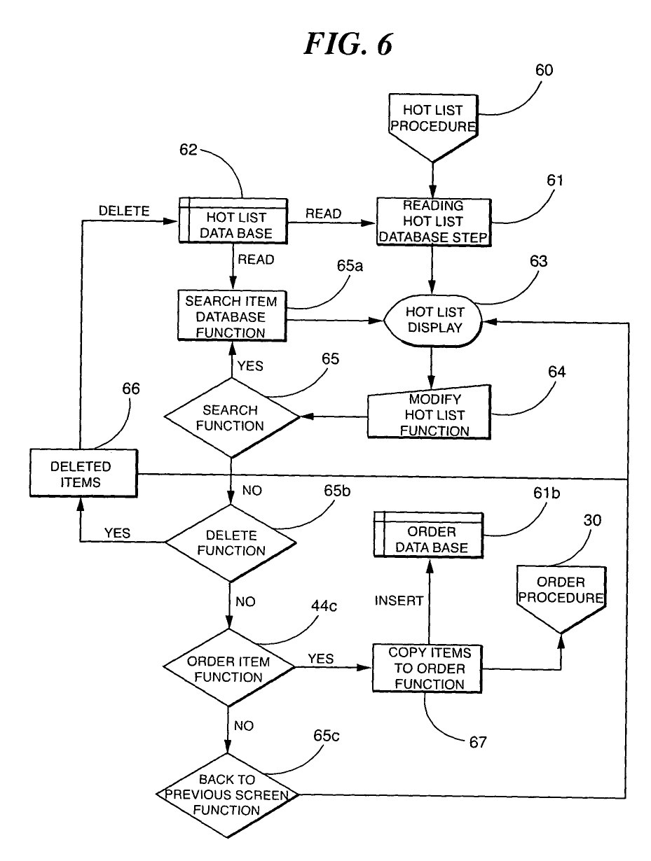

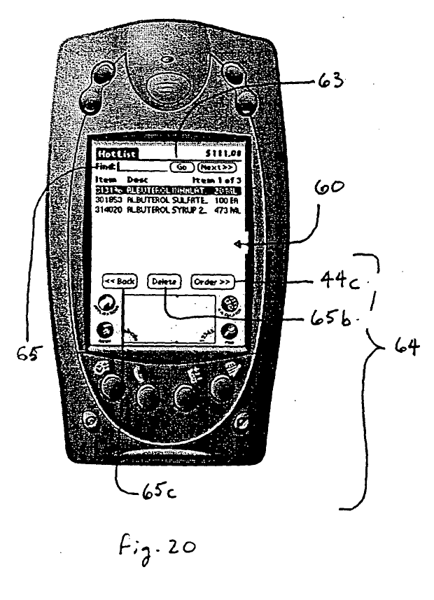

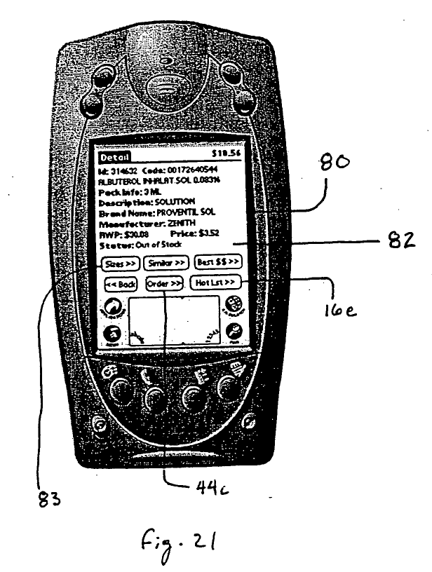

FIG. 1 additionally provides for the selection of Hot List Option 16e. Selecting Hot List Option 16e causes the software contained in Remote Database 14b to begin Hot List Procedure 60. As illustrated in FIG. 6, Hot List Procedure 60 includes Reading Hot List Database Step 61 that scans Hot List Database 62. Upon completion of Reading Hot List Database Step 61, a Hot List Display 63 is generated, as illustrated in FIG. 20, presenting the items most frequently ordered by the user, such as the examples shown as “ALBUTEROL INHALAT . . . 20ML,” “ALBUTEROL SULFATE . . . 100EA,” and “ALBUTEROL SYRUP 2 . . . 473ML.”

Hot List Display 63, as shown in FIGS. 6 and 20, permits the user to search Hot List Database 62, order an item contained in Hot List Database 62, delete an item contained in Hot List Database 62, and/or return to a previous screen through Modify Hot List Function 64.

If the user elects to search for an item in Hot List Database 62, Search Function 65 is selected to search item data in Hot List Database 62 via Search Item Database Function 65a. Resulting items obtained by the search can be scrolled through or otherwise viewed so as to view the items that match the item data obtained from search criteria entered. Should the user desire to delete an item from Hot List Database 62, Delete Function 65b is selected to facilitate the removal of Deleted Items 66 from Hot List 62. Additionally, if the user desires to order items, Order Item Function 44c is selected. Selecting Order Item Function 44c causes Copy Item To Order Function 67 to insert the item order into Order Database 31b. A Back To Previous Screen Function 65c is further provided in Hot List Display 63 for further navigation.

### Messages Option

Referring back to FIG. 1, the user can select Messages Option 16f. Selecting Messages Option 16f causes the software contained in Remote Database 14b to begin Messages Procedure 70. As illustrated in FIG. 7, Messages Procedure 70 includes Reading Messages Database Step 71 that scans Messages Database 72. Upon completion of Reading Messages Database Step 71, a Messages Display 73 is generated, as illustrated in FIG. 22. Messages contained in Messages Database 72 include, but are not limited to, information relating to items, such as drug information, and information relating to a previous order. As illustrated in FIG. 22, Messages Display 73 can, by way of example, make a statement such as, “Your order was accepted, but it was modified. Please check last order status for details.” A Back To Previous Screen Function 74 is provided in Messages Display 73.

### Scanner Function

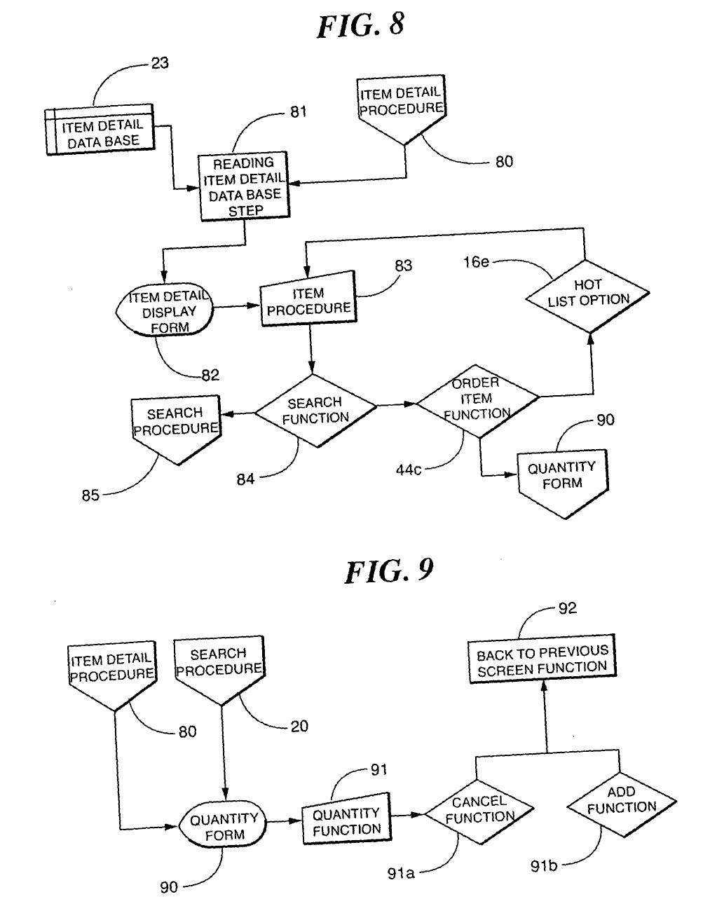

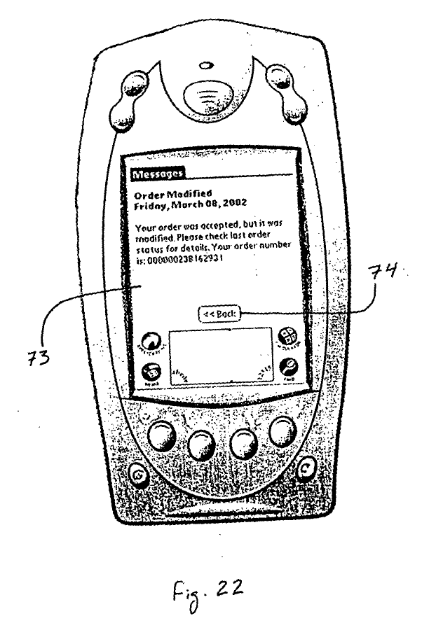

Additionally, as illustrated in FIG. 1, Scanner Function 16g can be engaged by the user to scan, as with a barcode scanner, a product code of an item. Scanning an item causes the software contained in Remote Database 14b to begin Item Detail Procedure 80. As illustrated in FIG. 8, Item Detail Procedure 80 includes Reading Item Detail Database Step 81 that scans Item Database 23. Upon completion of Reading Item Detail Database Step 81, an Item Detail Display Form 82 is generated, as illustrated in FIG. 21. By way of example, as shown in FIG. 21, Item Detail Display Form 82 can include an identification product code, product, pack information, description, brand name, manufacturer, prices and stock status.

### Item Detail

Item Detail Display Form 82, as shown in FIGS. 8 and 21, permits the user to search Item Database 23, order an item contained in Hot List Database 62, and add an item contained in Order Database 31b through Item Procedure 83.

If the user elects to search for an item in Item Database 23, Search Function 84 is selected to search items via Search Procedure 85. Search Procedure 85 can include, but is not limited to, searching for similar items (to the selected item), different sizes of an item, and best price for an item. If the user desires to order items, Order Item Function 44c is selected. Selecting Order Item Function 44c causes generates a Quantity Form 90, shown in FIG. 16, which the user completes so as to place the item and its desired quantity into Order Database 31b. Should the user desire to add an item from Item Database 23, Hot List Option 16e is selected to facilitate the addition of items to Hot List Database 62. A Back To Previous Screen Function (not shown) can be further provided for additional navigation.

Although only a few exemplary embodiments of the present invention have been described in detail above, those skilled in the art will readily appreciate that numerous modifications to the exemplary embodiments are possible without materially departing from the novel teachings and advantages of this invention. Accordingly, all such modifications are intended to be included within the scope of this invention as defined in the following appended claims.

What is claimed is:

1. A computer-implemented system for the transmission, reception, and storage of restocking information for pharmacy applications between a user and a provider, said system comprising:
a provider database having memory and a plurality of provider function databases, wherein at least one first provider function database of said plurality of provider function databases is in communication with at least one second provider function database of said plurality of provider function databases;
at least one remote user database having memory and capable of accessing said plurality of provider function databases; and
wherein said plurality of provider function databases is searchable by said at least one remote user database for item data and order data.

2. The computer-implemented system of claim 1 wherein said plurality of provider function databases update said memory of said at least one remote user database.

3. The computer-implemented system of claim 1 wherein said at least one remote user database updates said memory of said plurality of provider function databases.

4. The computer-implemented system of claim 1 wherein said at least a first provider function database of said plurality of provider function databases is in network communication with at least a second database of said plurality of databases.

5. The computer-implemented system of claim 1 wherein said first provider function database is a program database.

6. The computer-implemented system of claim 1 wherein said first provider function database is an item database.

7. The computer-implemented system of claim 1 wherein said first provider function database is an order database.

8. The computer-implemented system of claim 1 wherein said first provider function database is a wantbook database.

9. The computer-implemented system of claim 1 wherein said first provider function database is a last order database.

10. The computer-implemented system of claim 1 wherein said first provider function database is a hot list database.

11. The computer-implemented system of claim 1 wherein said first provider function database is a messages database.

12. The computer-implemented system of claim 1 wherein said second provider function database is a program database.

13. The computer-implemented system of claim 1 wherein said second provider function database is an item database.

14. The computer-implemented system of claim 1 wherein said second provider function database is an order database.

15. The computer-implemented system of claim 1 wherein said second provider function database is a wantbook database.

16. The computer-implemented system of claim 1 wherein said second provider function database is a last order database.

17. The computer-implemented system of claim 1 wherein said second provider function database is a hot list database.

18. The computer-implemented system of claim 1 wherein said second provider function database is a messages database.

19. The computer-implemented system of claim 1 wherein said at least one remote user database accesses said plurality of provider function databases via a modem.

20. The computer-implemented system of claim 19 wherein said modem is wireless.

21. The computer-implemented system of claim 1 wherein said at least one remote user database is contained in a handheld product scanning device.

22. The computer-implemented system of claim 1 wherein said item data includes an item identifier, item name, description, manufacturer, price, and status.

23. The computer-implemented system of claim 22 wherein said item data further includes available sizes, similar items, and best prices.

24. The computer-implemented system of claim 1 wherein said order data includes an item identifier, description, and quantity.

25. A computer-implemented system for the transmission, reception, and storage of restocking information for pharmacy applications between a user and a provider, said system comprising:
a provider database having memory and a plurality of provider function databases, wherein at least one first provider function database of said plurality of provider function databases is in network communication with at least one second provider function database of said plurality of provider function databases;
at least one remote user database contained in a handheld scanning device for scanning items having memory and a modem for accessing said plurality of provider function databases; and
wherein said plurality of provider function databases is searchable by said at least one remote user database for item data and order data.

26. The computer-implemented system of claim 25 wherein said plurality of provider function databases update said memory of said at least one remote user database.

27. The computer-implemented system of claim 25 wherein said at least one remote user database updates said memory of said plurality of provider function databases.

28. The computer-implemented system of claim 25 wherein said first provider function database is selected from the group consisting of a program database, item database, order database, wantbook database, last order database, hot list database, and messages database.

29. The computer-implemented system of claim 25 wherein said second provider function database is selected from the group consisting of a program database, item database, order database, wantbook database, last order database, hot list database, and messages database.

30. The computer-implemented system of claim 25 wherein said modem is wireless.

31. The computer-implemented system of claim 25 wherein said item data includes an item identifier, item name, description, manufacturer, price, and status.

32. The computer-implemented system of claim 31 wherein said item data further includes available sizes, similar items, and best prices.

33. The computer-implemented system of claim 25 wherein said order data includes an item identifier, description, and quantity.

34. A computer-implemented system for the transmission, reception, and storage of restocking information for pharmacy applications between a user and a provider, said system comprising:
a provider database having memory and a plurality of provider function databases, wherein at least one first provider function database of said plurality of provider function databases is in network communication with at least one second provider function database of said plurality of provider function databases, wherein said first and said second provider function databases are selected from the group consisting of a program database, item database, order database, wantbook database, last order database, hot list database, and messages database;
at least one remote user database contained in a handheld scanning device for scanning items having memory and a modem for accessing said plurality of provider function databases;
said plurality of provider function databases capable of updating said memory of said at least one remote user database;
said at least one remote user database capable of updating said memory of said plurality of provider function databases; and
wherein said plurality of provider function databases is searchable by said at least one remote user database for item data and order data, wherein said item data includes an item identifier, item name, description, manufacturer, price, status, available sizes, similar items, and best prices, and wherein said order data includes an item identifier, description, and quantity.

35. The computer-implemented system of claim 34 wherein said modem is wireless.

36. A method for transmitting, receiving, and storing restocking information for pharmacy applications between a user and a provider, said method comprising the steps of:
providing a provider database having memory and a plurality of provider function databases, wherein at least one first provider function database of said plurality of provider function databases is in communication with at least one second provider function database of said plurality of provider function databases;
accessing said plurality of provider function databases with at least one remote user database having memory; and
searching said plurality of provider function databases for item data and order data.

37. The method according to claim 36 further comprising the steps of:
inputting order data in said at least one remote user database having memory; and
updating said memory of said plurality of provider function databases and said memory of said at least one remote user database.
